(19) United States
(12) Patent Application Publication
(10) Pub. No.: US 2016/0162879 A1
(43) Pub. Date: Jun. 9, 2016

(54) ELECTRONIC PAYMENT SYSTEM AND REMOTE OR NEAR-FIELD PAYMENT METHOD

(71) Applicant: Datong MU, Beijing (CN)

(72) Inventor: Datong MU, Beijing (CN)

(21) Appl. No.: 14/907,281

(22) PCT Filed: Jul. 8, 2014
(86) PCT No.: PCT/CN2014/081829

§ 371 Date: Jan. 23, 2016

(30) Foreign Application Priority Data
Jul. 24, 2013 (CN) 201310314514.X

(51) Int. Cl. G06Q 20/32; G06Q 20/40

(52) U.S. Cl. CPC G06Q 20/3278; G06Q 20/40

(57) ABSTRACT

The electronic payment system and an electronic payment method based on remote communication or near field communication (NFC) includes a remote payment subsystem and an NFC payment subsystem, each of which includes a payment card, a payment terminal, a payment receiving card, and a payment receiving terminal. In the remote payment method, a bound remote payment account, a payment terminal, a payment card, and a payment password are used to execute remote payment. A bound remote payment receiving account, a payment receiving terminal, and a payment receiving card are used to execute remote payment receiving. In the NFC payment method, a bound NFC payment account, a payment terminal, and a payment card are used to execute NFC payment paying. A bound NFC payment receiving account, a payment receiving terminal, and a payment receiving card are used to execute NFC payment receiving.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention relates to the technical field of electronic payment, in particular to an electronic payment system and a payment method based on remote communication or near field communication (NFC).

2. Description of Related Art Including Information Disclosed Under 37 CFR 1.97 and 37 CFR 1.98.

Electronic payment includes remote payment and NFC payment, etc., and remote payment includes mobile phone payment, bank card acquiring, and prepaid card acceptance, etc.

Remote payment is applied in online environments, and requires payment password input to a POS terminal; therefore, remote payment lacks of security.

NFC payment is applied in offline environments. If the IC card or mobile phone used for NFC payment is lost or damaged, the electronic money stored in the IC card or mobile phone may be lost.

Hence, in view of the above-mentioned payment security problem, the present invention puts forth an electronic payment system and a payment method based on remote communication or near field communication (NFC).

### BRIEF SUMMARY OF THE INVENTION

The technical problem to be solved in the present invention is to provide an electronic payment system and a payment method based on remote communication or near field communication, which are used to execute electronic payment with a bound payment account, a payment terminal, a payment card and a payment password, and a bound payment receiving account, a payment receiving terminal, and a payment receiving card, so as to improve the security of electronic payment.

To solve the technical problem described above, the present invention employs the following technical scheme: An electronic payment system, comprising a remote payment subsystem and a NFC payment subsystem that are independent respectively:

the remote payment subsystem comprises a payment card, a payment terminal connected with the payment card through near field communication (NFC), a payment server connected with the payment terminal through a mobile communication network, a payment receiving server connected with the payment server through a data communication network, a payment receiving terminal connected with the payment receiving server through the mobile communication network, and a payment receiving card connected with the payment receiving terminal through NFC, wherein, the payment terminal is connected with the payment receiving terminal through NFC;

the NFC payment subsystem comprises a payment card, a payment terminal connected with the payment card through NFC, a payment receiving terminal connected with the payment terminal through NFC, and a payment receiving card connected with the payment receiving terminal through NFC.

In the remote payment subsystem:

the payment card is connected with the payment terminal through NFC, and is used to execute two-way authentication with the payment terminal, and execute two-way authentication with the payment server via the payment terminal;

the payment terminal is connected with the payment receiving terminal and the payment card through NFC respectively, and connected with the payment server through the mobile communication network, and is used to read and run system software of the payment terminal and remote payment application software of the payment terminal that are stored in a Read-Only form, after it is started up; is used to execute two-way authentication with the payment card and the payment server, and execute two-way authentication with the payment receiving terminal on the basis of an assigned key; and is used to send payment amount and payment password inputted into the payment terminal to the payment server;

the payment server is connected with the payment receiving server through the data communication network and connected with the payment terminal through the mobile communication network, and is used to execute two-way authentication with the payment terminal, and execute two-way authentication with the payment card via the payment terminal; is used to execute two-way authentication and key negotiation with the payment receiving server, and assign a key obtained through negotiation to the payment terminal; is used to prompt via the payment terminal for inputting payment amount and payment password into the payment terminal, and receive the payment amount and payment password via the payment terminal; and is used to transfer money equal to the payment amount from a remote payment account corresponding to the payment terminal in the payment server into a remote payment receiving account corresponding to the payment receiving terminal in the payment receiving server;

the payment receiving card is connected with the payment receiving terminal through NFC, and is used to execute two-way authentication with the payment receiving terminal, and execute two-way authentication with the payment receiving server via the payment receiving terminal;

the payment receiving terminal is connected with the payment receiving server through the mobile communication network, connected with the payment terminal and the payment receiving card through NFC respectively, and is used to read and run system software of the payment receiving terminal and remote payment application software of the payment receiving terminal that are stored in a Read-Only form, after it is started up; is used to execute two-way authentication with the payment receiving card and the payment receiving server, and execute two-way authentication with the payment terminal on the basis of an assigned key;

the payment receiving server is connected with the payment receiving terminal through the mobile communication network, connected with the payment server through the data communication network, and is used to execute two-way authentication with the payment receiving terminal, and execute two-way authentication with the payment receiving card via the payment receiving terminal; and is used to execute two-way authentication and key negotiation with the payment server, and assign a key obtained through negotiation to the payment receiving terminal.

In the NFC payment subsystem:

the payment card is connected with the payment terminal through NFC, and is used to execute two-way authentication with the payment terminal; is used to calculate A1=A1−P according to payment balance A1 and payment amount P applied for by the payment terminal, save payment details R1 and new payment balance A1, and approve the payment terminal to pay by NFC payment; is used to calculate A1=A1+P, and save payment details R1 and new payment balance A1 if it receives a notification on NFC payment failure from the payment terminal; and is used to take the stored payment details R1 and payment balance A1 as backup data for payment details R1′ and payment balance A1′ stored in the payment terminal;

the payment terminal is connected with the payment card and the payment receiving terminal through NFC respectively, and is used to read and run system software of the payment terminal and NFC payment application software of the payment terminal that are stored in a Read-Only form, after it is started up; is used to apply to the payment card for paying by NFC payment and send the payment amount P to the payment card, after it receives the inputted payment amount P; is used to execute two-way authentication with the payment receiving terminal after the payment card approves the payment terminal to pay by NFC payment, and send the payment amount P to the payment receiving terminal if the two-way authentication is successful; otherwise notify the payment card of the NFC payment failure; is used to transfer electronic money in amount P from a NFC payment account of the payment terminal to a NFC payment receiving account of the payment receiving terminal; is used to calculate A1′=A1−P according to payment balance A1′ and payment amount P, and save payment details R1′ and new payment balance A1′; and is used to take the stored payment details R1 and payment balance A1 as backup data for the payment details R1′ and payment balance A1′ stored in the payment terminal;

the payment receiving card is connected with the payment receiving terminal through NFC, and is used to execute two-way authentication with the payment receiving terminal after it receives an application for receiving NFC payment and the payment amount P sent from the payment receiving terminal; is used to calculate A2=A2+P according to payment receiving balance A2 and payment amount P, save payment receiving details R2 and new payment receiving balance A2, and approve the payment receiving terminal to pay by NFC payment; and is used to take the stored payment receiving details R2 and payment receiving balance A2 as backup data for payment receiving details R2′ and payment receiving balance A2′ stored in the payment receiving terminal;

the payment receiving terminal is connected with the payment receiving card and the payment terminal through NFC, and is used to read and run system software of the payment receiving terminal and NFC payment application software of the payment receiving terminal that are stored in a Read-Only form, after it is started up; is used to prompt for confirming the payment amount P after it receives the payment amount P sent from the payment terminal, and apply to the payment receiving card for paying by NFC payment and send the payment amount P to the payment receiving card after it receives a confirmation; is used to calculate A2′=A2′+P according to payment receiving balance A2′ and payment amount P, and save payment receiving details R2′ and new payment receiving balance A2′; and is used to take the stored payment receiving details R2′ and payment receiving balance A2′ as backup data for the payment receiving details R2 and payment receiving balance A2 stored in the payment receiving card.

Based on the technical scheme described above, the electronic payment system can be further improved as follows:

Furthermore, the payment terminal is a mobile terminal, and the payment receiving terminal is a mobile terminal or POS terminal, wherein, the mobile terminal comprises mobile phone, PDA, Tablet PC, or laptop computer, and, if the payment receiving terminal is a POS terminal, the electronic payment system doesn't comprise the payment receiving card.

Furthermore, the payment terminal and the payment receiving terminal employ MASK ROM, PROM, EPROM, OTP ROM, EEPROM or Flash ROM to store the Read-Only software, and the carrier of the ROM comprises Flash Memory, SD card, Micro SD card or SIM card.

Furthermore, the payment card and the payment receiving card are IC card, or the payment card and the payment receiving card are magnetic strip cards, and the magnetic strip cards are only used to provide card IDs.

Furthermore, the payment terminal communicates with the payment server, the payment receiving terminal, and the payment receiving server by voice communication, SMS communication, or data communication; the data communication network comprises wide area network (WAN), metropolitan area network (MAN), and local area network (LAN).

In correspondence to the remote payment subsystem described above, the technical scheme of the present invention further comprises a remote payment method, which comprises the following steps:

step 201: the payment terminal reads and runs system software of the payment terminal and remote payment application software of the payment terminal that are stored in a Read-Only form, after it is started up;

step 202: the payment terminal executes two-way authentication with the payment card and the payment server respectively, and the payment server executes two-way authentication with the payment card via the payment terminal;

step 203: the payment receiving terminal reads and runs system software of the payment receiving terminal and remote payment application software of the payment receiving terminal that are stored in a Read-Only form, after it is started up;

step 204: the payment receiving terminal executes two-way authentication with the payment receiving card and the payment receiving server respectively, and the payment receiving server executes two-way authentication with the payment receiving card via the payment receiving terminal;

step 205: the payment terminal and/or the payment card is swiped on the payment receiving terminal, the payment receiving terminal reads the Payment ID of the payment terminal and/or the payment card, and sends the Payment ID to the payment receiving server, and the payment receiving server sends the Payment ID to the payment server;

step 206: the payment server executes two-way authentication and key negotiation with the payment receiving server, the payment server assigns a key obtained through negotiation to the payment terminal; the payment receiving server assigns a key obtained through negotiation to the payment receiving terminal, and the payment terminal executes two-way authentication with the payment receiving terminal on the basis of the assigned keys;

step 207: the payment server prompts via the payment terminal for inputting payment amount and payment password into the payment terminal, and receives the payment amount and payment password via the payment terminal;

step 208: the payment server transfers money equal to the payment amount from a remote payment account corresponding to the payment terminal in the payment server to a remote payment receiving account corresponding to the payment receiving terminal in the payment receiving server, after the payment server confirms the received payment password is correct.

A beneficial effect of the remote payment method described above is: end-to-end and user-to-user remote payment security is ensured.

Based on the technical scheme described above, the remote payment method can be further improved as follows:

Furthermore, in the step 201, the payment terminal reads and runs system software of the payment terminal and remote payment application software of the payment terminal that are stored in a Read-Only form, after it is started up. In the step 203, the payment receiving terminal reads and runs system software of the payment receiving terminal and remote payment application software of the payment receiving terminal that are stored in a Read-Only form, after it is started up.

A beneficial effect of the further improved technical scheme described above is: the harms of computer viruses to the payment terminal and the payment receiving terminal are prevented.

Furthermore, in the step 202, the payment card executes two-way authentication with the payment terminal, and executes two-way authentication with the payment server via the payment terminal. In the step 204, the payment receiving card executes two-way authentication with the payment receiving terminal, and executes two-way authentication with the payment receiving server via the payment receiving terminal. In the step 206, the payment terminal executes two-way authentication with the payment receiving terminal on the basis of the keys assigned by the payment server and the payment receiving server.

A beneficial effect of the further improved technical scheme described above is: the authenticity of the components involved in the remote payment is ensured.

Furthermore, in the step 207, the payment server receives remote payment confirmation information via the payment terminal, and the remote payment confirmation information comprises the payment password, a DTMF signal corresponding to keystroke confirmation operation, remote payment confirmation information of the payment terminal, and remote payment confirmation of the payment card and/or a biometric signature.

A beneficial effect of the further improved technical scheme described above is: the confidentiality and privacy of the remote payment is enhanced.

Furthermore, in the steps, the remote payment account, the payment terminal, the payment card, and the remote payment confirmation information are bound to each other, and the remote payment receiving account, the payment receiving terminal, and the payment receiving card are bound to each other.

A beneficial effect of the further improved technical scheme described above is: the controllability of the remote payment is enhanced.

Furthermore, in each of the steps, electronic payment information is generated and can be transmitted by means of a QR code, the electronic payment information comprises: ID of the payment card, ID of the payment receiving card, ID of the payment terminal and/or ID of the payment receiving terminal, and serial number, digital certificate, payment amount, invoice, shopping list and/or consumption points, the serial number comprises the identity information of the payment server or the identity information of the payment receiving server, and is used to initiate remote payment.

A beneficial effect of the further improved technical scheme described above is: the compatibility of the remote payment is enhanced.

In correspondence to the NFC payment subsystem described above, the technical scheme of the present invention further comprises an NFC payment method, which comprises the following steps:

step 401: the payment receiving terminal reads and runs system software of the payment receiving terminal and NFC payment application software of the payment receiving terminal that are stored in a Read-Only form, after it is started up;

step 402: the payment terminal reads and runs system software of the payment terminal and NFC payment application software of the payment terminal that are stored in a Read-Only form, after it is started up;

step 403: a payment amount P is inputted into the payment terminal;

step 404: the payment terminal applies to the payment card for paying by NFC payment, and sends the payment amount P to the payment card;

step 405: the payment card executes two-way authentication with the payment terminal;

step 406: the payment card calculates A1=A1−P according to payment balance A1 and payment amount P, and saves payment details R1 and new payment balance A1;

step 407: the payment card approves the payment terminal to pay by NFC payment;

step 408: the payment terminal executes two-way authentication with the payment receiving terminal;

step 409: the payment terminal judges whether the two-way authentication with the payment receiving terminal is successful; if the two-way authentication is successful, the execution jumps to step 412; otherwise the execution jumps to step 410;

step 410: the payment terminal notifies the payment card of the NFC payment failure;

step 411: the payment card calculates A1=A1+P according to payment balance A1 and payment amount P, and saves payment details R1 and new payment balance A1; thus, the entire process is terminated;

step 412: the payment terminal sending the payment amount P to the payment receiving terminal;

step 413: the payment receiving terminal prompts for confirming the payment amount P, applies to the payment receiving card for paying by NFC payment, and sends the payment amount P to the payment receiving card after it receives a confirmation;

step 414: the payment receiving card executes two-way authentication with the payment receiving terminal;

step 415: the payment receiving card calculates A2=A2+P according to payment receiving balance A2 and payment amount P, and saves payment receiving details R2 and new payment receiving balance A2;

step 416: the payment receiving card approves the payment receiving terminal to pay by NFC payment;

step 417: the payment terminal transfers electronic money in amount P from an NFC payment account of the payment terminal to an NFC payment receiving account of the payment receiving terminal;

step 418: the payment terminal calculates A1=A1′−P according to payment balance A1′ and payment amount P, and saves payment details R1′ and new payment balance A1 ‘; the payment receiving terminal calculates A2′=A2′+P according to payment receiving balance A2’ and payment amount P, and saves payment receiving details R2′ and new payment receiving balance A2′.

A beneficial effect of the NFC payment method described above is: end-to-end and user-to-user NFC payment security is ensured.

Based on the technical scheme described above, the NFC payment method can be further improved as follows:

Furthermore, in the step 401, the payment receiving terminal reads and runs system software of the payment receiving terminal and NFC payment application software of the payment receiving terminal that are stored in a Read-Only form, after it is started up; in the step 402, the payment terminal reads and runs system software of the payment terminal and NFC payment application software of the payment terminal that are stored in a Read-Only form, after it is started up.

A beneficial effect of the further improved technical scheme described above is: the harms of computer viruses to the payment terminal and the payment receiving terminal are prevented.

Furthermore, in the step 405, the payment card executes two-way authentication with the payment terminal; in the step 414, the payment receiving card executes two-way authentication with the payment receiving terminal.

A beneficial effect of the further improved technical scheme described above is: the authenticity of the components involved in the NFC payment is ensured.

Furthermore, in the steps, the NFC payment account, the payment terminal, and the payment card are bound to each other, and the NFC payment receiving account, the payment receiving terminal, and the payment receiving card are bound to each other.

A beneficial effect of the further improved technical scheme described above is: The controllability of the NFC payment is enhanced.

Furthermore, in each of the steps, electronic payment information is generated and can be transmitted by means of a QR code, and the electronic payment information comprises NFC payment protocol, digital certificate, payment amount, invoice, shopping list and/or consumption points.

A beneficial effect of the further improved technical scheme described above is: The compatibility of the NFC payment is enhanced.

Furthermore, the payment details R1 and payment balance A1 stored in the payment card and the payment details R1′ and payment balance A1′ stored in the payment terminal serve as backup data for each other; and the payment receiving details R2 and payment receiving balance A2 stored in the payment receiving card and the payment receiving details R2′ and payment receiving balance A2′ stored in the payment receiving terminal serve as backup data for each other. If either the payment card or the payment terminal is lost or damaged, the other party can authenticate the payment details and payment balance of the lost or damaged party by virtue of the payment details and payment balance stored in it; if either the payment receiving card or the payment receiving terminal is lost or damaged, the other party can authenticate the payment receiving details and payment receiving balance of the lost or damaged party by virtue of the payment receiving details and payment receiving balance stored in it.

A beneficial effect of the further improved technical scheme described above is: the usability of the electronic money is enhanced.

The system and method provided in the present invention ensure end-to-end and user-to-user security of electronic payment.

### BRIEF DESCRIPTION OF THE SEVERAL VIEWS OF THE DRAWINGS

FIG. 1A is a schematic structural diagram of the electronic payment system in embodiment 1 of the present invention.

FIG. 1B is a schematic structural diagram of the remote payment subsystem in embodiment 1 of the present invention.

FIG. 1C is a schematic structural diagram of the NFC payment subsystem in embodiment 1 of the present invention.

FIG. 2 is a flow diagram of the remote payment method in embodiment 2 of the present invention.

FIG. 3A is a schematic structural diagram of the remote payment system that employs a POS terminal in embodiment 3 of the present invention.

FIG. 3B is a flow diagram of the remote payment method that employs a POS terminal in embodiment 3 of the present invention.

FIG. 4 is a flow diagram of the NFC payment method in embodiment 4 of the present invention.

FIG. 5A is a schematic structural diagram of the NFC payment system that employs a POS terminal in embodiment 5 of the present invention.

FIG. 5B is a flow diagram of the NFC payment method that employs a POS terminal in embodiment 5 of the present invention.

In the Figures, 11—remote payment subsystem; 12—NFC payment subsystem; 101—payment card; 102—payment terminal; 103—payment server; 104—payment receiving card; 105—payment receiving terminal; 106—payment receiving server.

### DETAILED DESCRIPTION OF THE INVENTION

Hereunder the principle and features of the present invention will be detailed with reference to the accompanying drawings. However, it should be noted that the embodiments are provided only to interpret the present invention but don't constitute any limitation to the scope of the present invention.

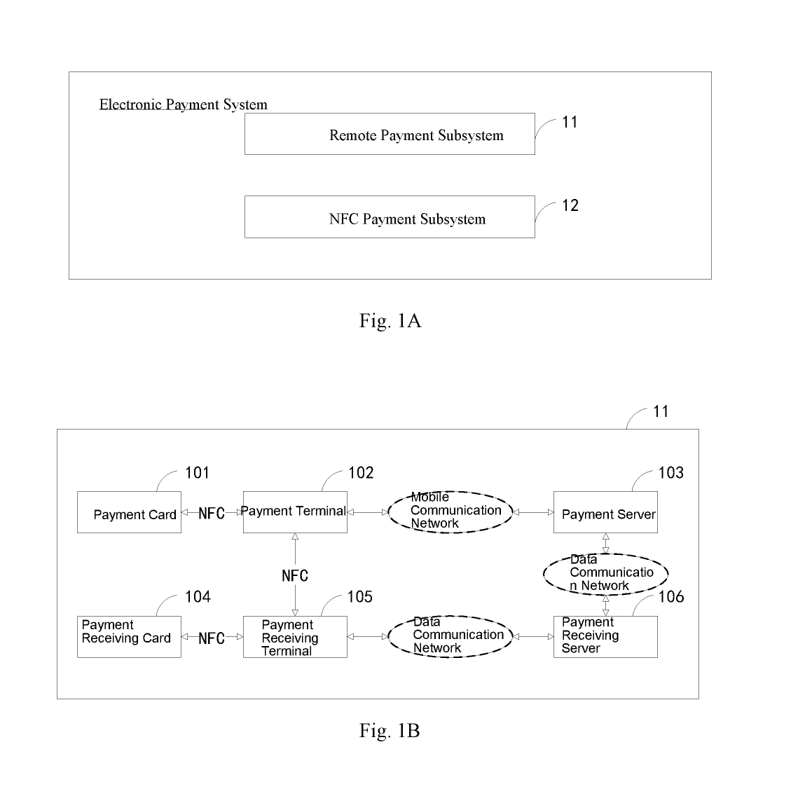

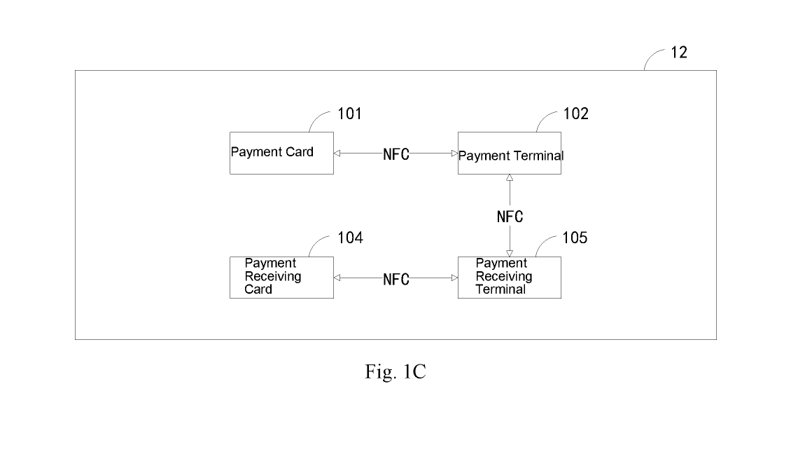

As shown in FIG. 1A, in embodiment 1 of the present invention, an electronic payment system is provided, comprising a remote payment subsystem 11 and an NFC payment subsystem 12 that are independent respectively.

As shown in FIG. 1B, the remote payment subsystem 11 comprises: a payment card 101, a payment terminal 102, a payment server 103, a payment receiving card 104, a payment receiving terminal 105, and a payment receiving server 106;

the payment card 101 is connected with the payment terminal 102 through NFC, and is used to execute two-way authentication with the payment terminal 102, and execute two-way authentication with the payment server 103 via the payment terminal 102;

the payment terminal 102 is connected with the payment receiving terminal 105 and the payment card 101 through NFC respectively, and connected with the payment server 103 through a mobile communication network, and is used to read and run system software of the payment terminal and remote payment application software of the payment terminal that are stored in a Read-Only form, after it is started up; is used to execute two-way authentication with the payment card 101 and the payment server 103, and execute two-way authentication with the payment receiving terminal 105 on the basis of an assigned key; and is used to send payment amount and payment password inputted into the payment terminal 102 to the payment server 103;

the payment server 103 is connected with the payment receiving server 106 through a data communication network and connected with the payment terminal 102 through the mobile communication network, and is used to execute two-way authentication with the payment terminal 102, and execute two-way authentication with the payment card 101 via the payment terminal 102; is used to execute two-way authentication and key negotiation with the payment receiving server 106, and assign a key obtained through negotiation to the payment terminal 102; is used to prompt via the payment terminal 102 for inputting payment amount and payment password into the payment terminal 102, and receive the payment amount and payment password via the payment terminal 102; and is used to transfer money equal to the payment amount from a remote payment account corresponding to the payment terminal 102 in the payment server 103 into a remote payment receiving account corresponding to the payment receiving terminal 105 in the payment receiving server 106;

the payment receiving card 104 is connected with the payment receiving terminal 105 through NFC, and is used to execute two-way authentication with the payment receiving terminal 105, and execute two-way authentication with the payment receiving server 106 via the payment receiving terminal 105;

the payment receiving terminal 105 is connected with the payment receiving server 106 through the mobile communication network, connected with the payment terminal 102 and the payment receiving card 104 through NFC respectively, and is used to read and run system software of the payment receiving terminal and remote payment application software of the payment receiving terminal that are stored in a Read-Only form, after it is started up; is used to execute two-way authentication with the payment receiving card 104 and the payment receiving server 106, and execute two-way authentication with the payment terminal 102 on the basis of an assigned key;

the payment receiving server 106 is connected with the payment receiving terminal 105 through the mobile communication network, connected with the payment server 103 through the data communication network, and is used to execute two-way authentication with the payment receiving terminal 105, and execute two-way authentication with the payment receiving card 104 via the payment receiving terminal 105; and is used to execute two-way authentication and key negotiation with the payment server 103, and assign a key obtained through negotiation to the payment receiving terminal 105.

As shown in FIG. 1C, the NFC payment subsystem 12 comprises: a payment card 101, a payment terminal 102, a payment receiving card 104, and a payment receiving terminal 105;

the payment card 101 is connected with the payment terminal 102 through NFC, and is used to execute two-way authentication with the payment terminal 102; is used to calculate A1=A1−P according to payment balance A1 and payment amount P applied for by the payment terminal 102, save payment details R1 and new payment balance A1, and approve the payment terminal 102 to pay by NFC payment; is used to calculate A1=A1+P, and save payment details R1 and new payment balance A1 if it receives a notification on NFC payment failure from the payment terminal 102; and is used to take the stored payment details R1 and payment balance A1 as backup data for payment details R1′ and payment balance A1′ stored in the payment terminal 102;

the payment terminal 102 is connected with the payment card 101 and the payment receiving terminal 105 through NFC respectively, and is used to read and run system software of the payment terminal and NFC payment application software of the payment terminal that are stored in a Read-Only form, after it is started up; is used to apply to the payment card 101 for paying by NFC payment and send the payment amount P to the payment card 101, after it receives the inputted payment amount P; is used to execute two-way authentication with the payment receiving terminal 105 after the payment card 101 approves the payment terminal 102 to pay by NFC payment, and send the payment amount P to the payment receiving terminal 105 if the two-way authentication is successful; otherwise notify the payment card 101 of the NFC payment failure; is used to transfer electronic money in amount P from a NFC payment account of the payment terminal 102 to a NFC payment receiving account of the payment receiving terminal 105; is used to calculate A1′=A1′−P according to payment balance A1′ and payment amount P, and save payment details R1′ and new payment balance A1′; and is used to take the stored payment details R1′ and payment balance A1′ as backup data for the payment details R1 and payment balance A1 stored in the payment terminal 101;

the payment receiving card 104 is connected with the payment receiving terminal 105 through NFC, and is used to execute two-way authentication with the payment receiving terminal 105 after it receives an application for receiving NFC payment and the payment amount P sent from the payment receiving terminal 105; is used to calculate A2=A2+P according to payment receiving balance A2 and payment amount P, save payment receiving details R2 and new payment receiving balance A2, and approve the payment receiving terminal 105 to pay by NFC payment; and is used to take the stored payment receiving details R2 and payment receiving balance A2 as backup data for payment receiving details R2′ and payment receiving balance A2′ stored in the payment receiving terminal 105;

the payment receiving terminal 105 is connected with the payment receiving card 104 and the payment terminal 102 through NFC, and is used to read and run system software of the payment receiving terminal and NFC payment application software of the payment receiving terminal that are stored in a Read-Only form, after it is started up; is used to prompt for confirming the payment amount P after it receives the payment amount P sent from the payment terminal 102, and apply to the payment receiving card 104 for paying by NFC payment and send the payment amount P to the payment receiving card 104 after it receives a confirmation; is used to calculate A2′=A2′+P according to payment receiving balance A2′ and payment amount P, and save payment receiving details R2′ and new payment receiving balance A2′; and is used to take the stored payment receiving details R2′ and payment receiving balance A2′ as backup data for the payment receiving details R2 and payment receiving balance A2 stored in the payment receiving card 104.

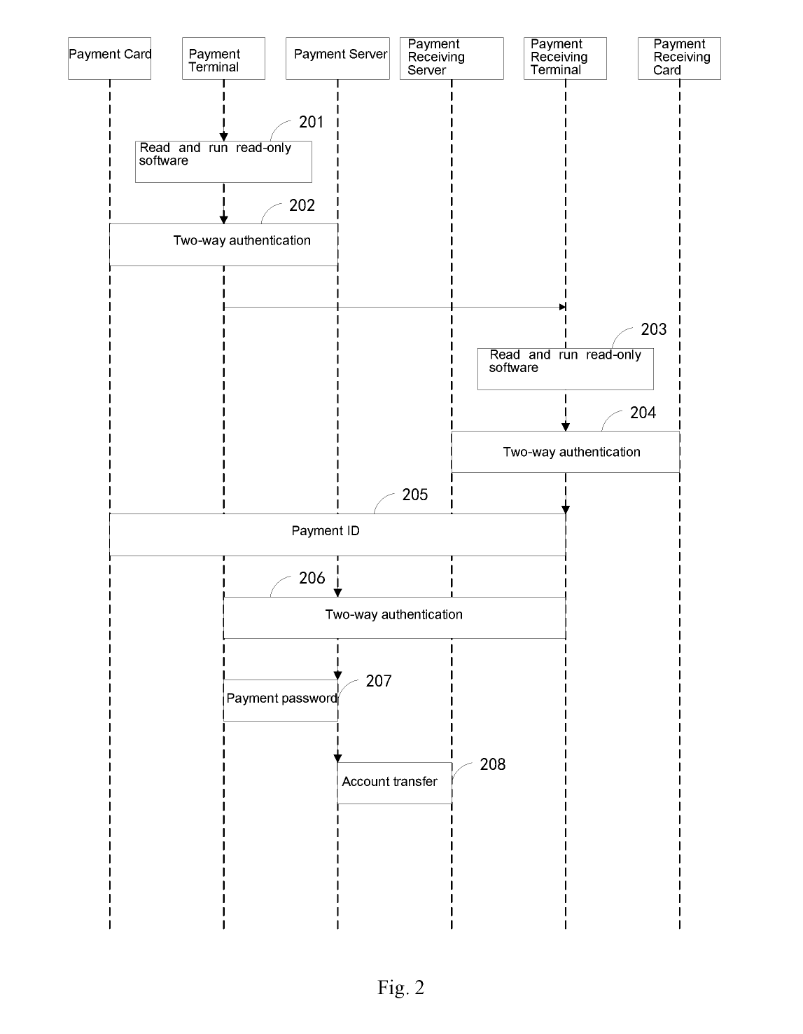

As shown in FIG. 2, in embodiment 2 of the present invention, a remote payment method is provided. Before the method is used, a payer applies to a payment server for opening an account, the payment server writes certification information into a payment terminal of the payer, so that the payment server and the payment terminal can execute two-way authentication with each other; the payment server writes certification information into a payment card, so that the payment server and the payment card can execute two-way authentication with each other; the payment server writes certification information into the payment terminal and the payment card, so that the payment terminal and the payment card can execute two-way authentication with each other; the payment server opens a remote payment account for the payer, and saves a payment password provided by the payer for the remote payment account; the payment server binds the remote payment account, the payment password, the payment terminal and the payment card to each other; a payment receiver applies to a payment receiving server for opening an account, and the payment receiving server writes certification information into a payment receiving terminal of the payment receiver, so that the payment receiving server and the payment receiving terminal can execute two-way authentication with each other; the payment receiving server writes certification information into a payment receiving card, so that the payment receiving server and the payment receiving card can execute two-way authentication with each other; the payment receiving server writes certification information into the payment receiving terminal and the payment receiving card, so that the payment receiving terminal and the payment receiving card can execute two-way authentication with each other; the payment receiving server opens a remote payment receiving account for the payment receiver, and binds the remote payment receiving account, the payment receiving terminal, and the payment receiving card to each other. The method comprises the following steps:

step 201: the payment terminal reads and runs system software of the payment terminal and remote payment application software of the payment terminal that are stored in a Read-Only form, after it is started up;

step 202: the payment terminal executes two-way authentication with the payment card and the payment server respectively, and the payment server executes two-way authentication with the payment card via the payment terminal;

step 203: the payment receiving terminal reads and runs system software of the payment receiving terminal and remote payment application software of the payment receiving terminal that are stored in a Read-Only form, after it is started up;

step 204: the payment receiving terminal executes two-way authentication with the payment receiving card and the payment receiving server respectively, and the payment receiving server executes two-way authentication with the payment receiving card via the payment receiving terminal;

step 205: the payment terminal and/or the payment card is swiped on the payment receiving terminal, the payment receiving terminal reads the Payment ID of the payment terminal and/or the payment card, and sends the Payment ID to the payment receiving server, and the payment receiving server sends the Payment ID to the payment server;

step 206: the payment server executes two-way authentication and key negotiation with the payment receiving server, the payment server assigns a key obtained through negotiation to the payment terminal; the payment receiving server assigns a key obtained through negotiation to the payment receiving terminal, and the payment terminal executes two-way authentication with the payment receiving terminal on the basis of the assigned keys;

step 207: the payment server prompts via the payment terminal for inputting payment amount and payment password into the payment terminal, and receives the payment amount and payment password via the payment terminal;

step 208: the payment server transfers money equal to the payment amount from a remote payment account corresponding to the payment terminal in the payment server to a remote payment receiving account corresponding to the payment receiving terminal in the payment receiving server, after the payment server confirms the received payment password is correct.

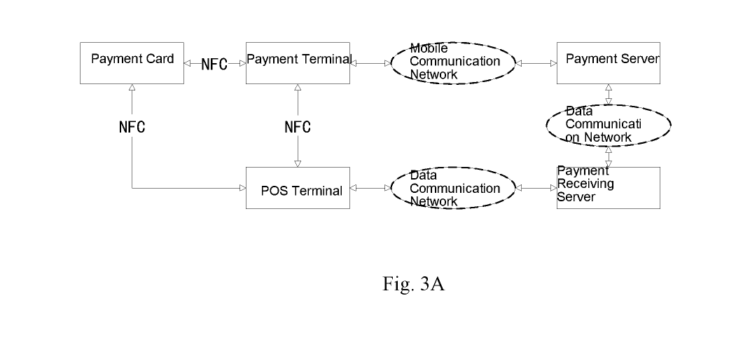

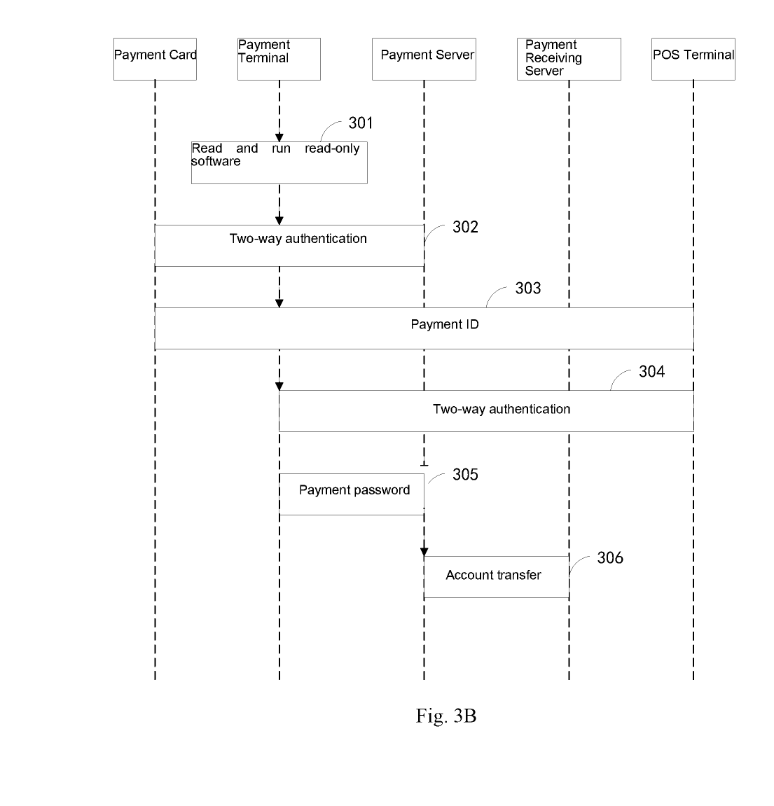

In embodiment 3 of the present invention, a remote payment system and a remote payment method that employ a POS terminal are provided. As shown in FIG. 3A, the system comprises: a payment card, a payment terminal, a payment server, a payment receiving server, and a POS terminal, wherein, the payment card is connected with the payment terminal and the POS terminal through NFC respectively; the payment terminal is connected with the POS terminal through NFC, and is connected with the payment server through a mobile communication network; the payment server is connected with the payment receiving server through a data communication network; the POS terminal is connected with the payment receiving server through the data communication network. Before the method is used, a payer applies to the payment server for opening an account, and the payment server writes certification information into the payment terminal of the payer, so that the payment server and the payment terminal can execute two-way authentication with each other; the payment server writes certification information into a payment card, so that the payment server and the payment card can execute two-way authentication with each other; the payment server writes certification information into the payment terminal and the payment card, so that the payment terminal and the payment card can execute two-way authentication with each other; the payment server opens a remote payment account for the payer, and saves a payment password provided by the payer for the remote payment account; the payment server binds the remote payment account, the payment password, the payment terminal and the payment card to each other; a payment receiver applies to the payment receiving server for opening an account, and the payment receiving server writes certification information into the POS terminal, so that the payment receiving server and the POS terminal can execute two-way authentication with each other; the payment receiving server opens a remote payment receiving account for the payment receiver, and binds the remote payment receiving account with the POS terminal. As shown in FIG. 3B, the method comprises the following steps:

step 301: the payment terminal reads and runs system software of the payment terminal and remote payment application software of the payment terminal that are stored in a Read-Only form, after it is started up;

step 302: the payment terminal executes two-way authentication with the payment card and the payment server respectively, and the payment server executes two-way authentication with the payment card via the payment terminal;

step 303: the payment terminal and/or the payment card is swiped on the POS terminal, the POS terminal reads the Payment ID of the payment terminal and/or the payment card, and sends the Payment ID to the payment receiving server, and the payment receiving server sends the Payment ID to the payment server;

step 304: the payment receiving server executes two-way authentication with the POS terminal, the payment server executes two-way authentication and key negotiation with the payment receiving server, the payment server assigns a key obtained through negotiation to the payment terminal, the payment receiving server assigns a key obtained through negotiation to the POS terminal, and the payment terminal and the POS terminal execute two-way authentication with each other on the basis of the assigned keys;

step 305: the payment server prompts via the payment terminal for inputting payment amount and payment password into the payment terminal, and receives the payment amount and payment password via the payment terminal;

step 306: the payment server transfers money equal to the payment amount from a remote payment account corresponding to the payment terminal in the payment server to a remote payment receiving account corresponding to the POS terminal in the payment receiving server, after the payment server confirms the received payment password is correct.

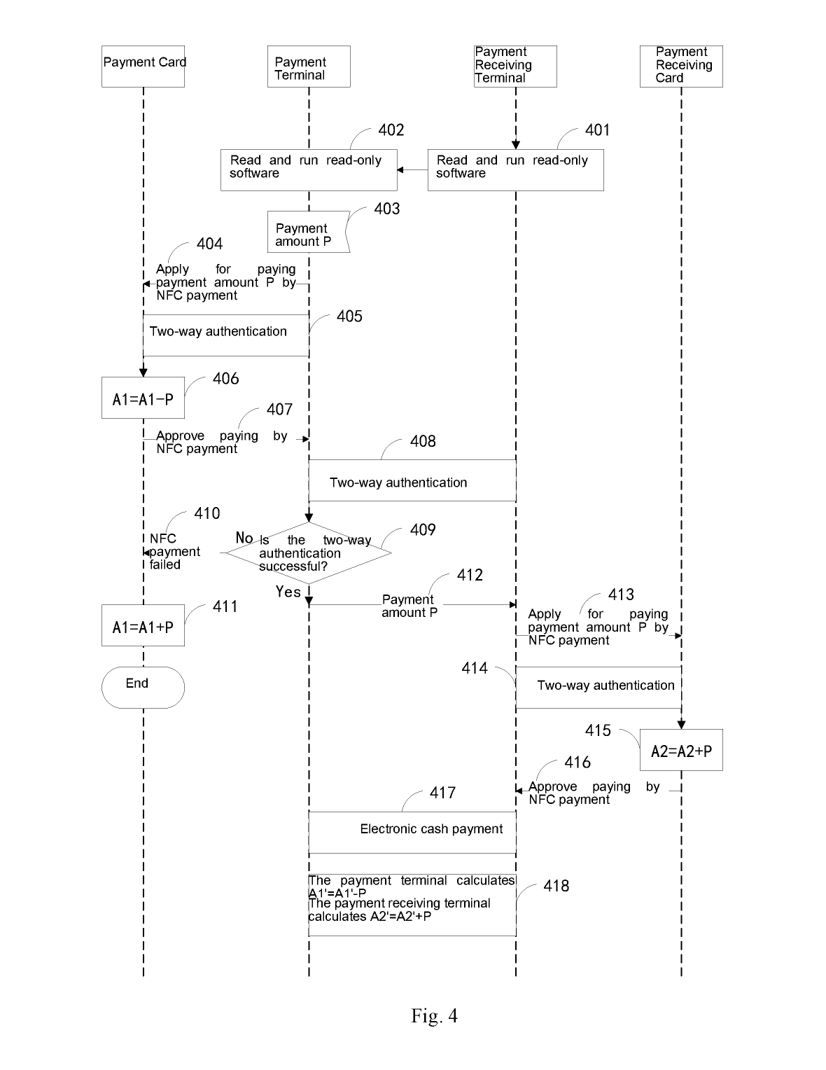

As shown in FIG. 4, in embodiment 4 of the present invention, an NFC payment method is provided. Before the method is used, a payer applies to payment institution for opening an account, and the payment institution writes certification information into a payment terminal and a payment card of the payer, so that the payment terminal and the payment card can execute two-way authentication with each other; the payment institution opens an NFC payment account for the payer, and binds the NFC payment account, the payment terminal, and the payment card to each other; the payer recharges, and the payment institution writes the payment balance A1 of the NFC payment account into the payment card, and writes the payment balance A1′ of the NFC payment account into the payment terminal, where, A1=A1; a payment receiver applies to the payment institution for opening an account, and the payment institution writes certification information into a payment receiving terminal and a payment receiving card of the payer, so that the payment receiving terminal and the payment receiving card can execute two-way authentication with each other; the payment institution opens an NFC payment receiving account for the payment receiver, and binds the NFC payment receiving account, the payment receiving terminal, and the payment receiving card to each other; the payment institution writes the payment receiving balance A2 of the NFC payment receiving account into the payment receiving card, and writes the payment receiving balance A2′ of the NFC payment receiving account into the payment receiving terminal, where, A2′=A2. The method comprises the following steps:

step 401: the payment receiving terminal reads and runs system software of the payment receiving terminal and NFC payment application software of the payment receiving terminal that are stored in a Read-Only form, after it is started up;

step 402: the payment terminal reads and runs system software of the payment terminal and NFC payment application software of the payment terminal that are stored in a Read-Only form, after it is started up;

step 403: a payment amount P is inputted into the payment terminal;

step 404: the payment terminal applies to the payment card for paying by NFC payment, and sends the payment amount P to the payment card;

step 405: the payment card executes two-way authentication with the payment terminal;

step 406: the payment card calculates A1=A1-P according to payment balance A1 and payment amount P, and saves payment details R1 and new payment balance A1;

step 407: the payment card approves the payment terminal to pay by NFC payment;

step 408: the payment terminal executes two-way authentication with the payment receiving terminal;

step 409: the payment terminal judges whether the two-way authentication with the payment receiving terminal is successful; if the two-way authentication is successful, the execution jumps to step 412; otherwise the execution jumps to step 410;

step 410: the payment terminal notifies the payment card of the NFC payment failure;

step 411: the payment card calculates A1=A1+P according to payment balance A1 and payment amount P, and saves payment details R1 and new payment balance A1; thus, the entire process is terminated;

step 412: the payment terminal sending the payment amount P to the payment receiving terminal;

step 413: the payment receiving terminal prompts for confirming the payment amount P, and the payment receiving terminal applies to the payment receiving card for paying by NFC payment, and sends the payment amount P to the payment receiving card after it receives a confirmation;

step 414: the payment receiving card executes two-way authentication with the payment receiving terminal;

step 415: the payment receiving card calculates A2=A2+P according to payment receiving balance A2 and payment amount P, and saves payment receiving details R2 and new payment receiving balance A2;

step 416: the payment receiving card approves the payment receiving terminal to pay by NFC payment;

step 417: the payment terminal transfers electronic money in amount P from an NFC payment account of the payment terminal to an NFC payment receiving account of the payment receiving terminal;

step 418: the payment terminal calculates A1=A1′−P according to payment balance A1′ and payment amount P, and saves payment details R1′ and new payment balance A1 ‘; the payment receiving terminal calculates A2′=A2′+P according to payment receiving balance A2’ and payment amount P, and saves payment receiving details R2′ and new payment receiving balance A2′.

In addition, the payment details R1 and payment balance A1 stored in the payment card and the payment details R1′ and payment balance A1′ stored in the payment terminal serve as backup data for each other; and the payment receiving details R2 and payment receiving balance A2 stored in the payment receiving card and the payment receiving details R2′ and payment receiving balance A2′ stored in the payment receiving terminal serve as backup data for each other. If either the payment card or the payment terminal is lost or damaged, the other party can authenticate the payment details and payment balance of the lost or damaged party by virtue of the payment details and payment balance stored in it; if either the payment receiving card or the payment receiving terminal is lost or damaged, the other party can authenticate the payment receiving details and payment receiving balance of the lost or damaged party by virtue of the payment receiving details and payment receiving balance stored in it.

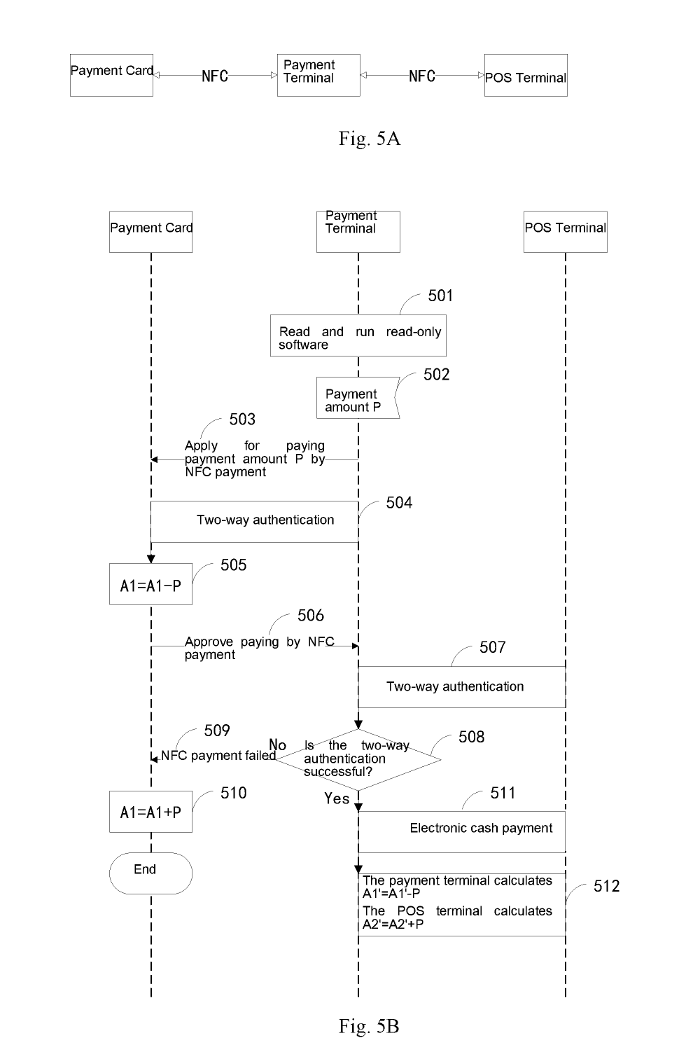

In embodiment 5 of the present invention, an NFC payment system and an NFC payment method that employ a POS terminal are provided. As shown in FIG. 5A, the system comprises: a payment card, a payment terminal, and a POS terminal, wherein, the payment card is connected with the payment terminal through NFC; the payment terminal is connected with the POS terminal through NFC. Before the method is used, a payer applies to a payment institution for opening an account, and the payment institution writes certification information into the payment terminal and the payment card of the payer, so that the payment terminal and the payment card can execute two-way authentication with each other; the payment institution opens an NFC payment account for the payer, and binds the NFC payment account, the payment terminal, and the payment card to each other; the payer recharges, and the payment institution writes the payment balance A1 of the NFC payment account into the payment card, and writes the payment balance A1′ of the NFC payment account into the payment terminal, where, A1=A1; the payment institution opens an NFC payment receiving account for the POS terminal, and writes the payment receiving balance A2′ of the NFC payment receiving account into the POS terminal. As shown in FIG. 5B, the method comprises the following steps:

step 501: the payment terminal reads and runs system software of the payment terminal and NFC payment application software of the payment terminal that are stored in a Read-Only form, after it is started up;

step 502: a payment amount P is inputted into the payment terminal;

step 503: the payment terminal applies to the payment card for paying by NFC payment, and sends the payment amount P to the payment card;

step 504: the payment card executes two-way authentication with the payment terminal;

step 505: the payment card calculates A1=A1−P according to payment balance A1 and payment amount P, and saves payment details R1 and new payment balance A1;

step 506: the payment card approves the payment terminal to pay by NFC payment;

step 507: the payment terminal executes two-way authentication with the POS terminal;

step 508: the payment terminal judges whether the two-way authentication with the POS terminal is successful; if the two-way authentication is successful, the execution jumps to step 511; otherwise the execution jumps to step 509;

step 509: the payment terminal notifies the payment card of the NFC payment failure;

step 510: the payment card calculates A1=A1+P according to payment balance A1 and payment amount P, and saves payment details R1 and new payment balance A1; thus, the entire process is terminated;

step 511: the payment terminal transfers electronic money in amount P from an NFC payment account of the payment terminal to an NFC payment receiving account of the POS terminal;

step 512: the payment terminal calculates A1=A1′−P according to payment balance A1′ and payment amount P, and saves payment details R1′ and new payment balance A1 ‘; the POS terminal calculates A2′=A2′+P according to payment receiving balance A2’ and payment amount P, and saves payment receiving details R2′ and new payment receiving balance A2′.

In addition, the payment details R1 and payment balance A1 stored in the payment card and the payment details R1′ and payment balance A1′ stored in the payment terminal serve as backup data for each other. If either the payment card or the payment terminal is lost or damaged, the other party can authenticate the payment details and payment balance of the lost or damaged party by virtue of the payment details and payment balance stored in it.

In embodiment 6 of the present invention, a simplified scheme for the embodiment 3 of the present invention is provided, wherein, the payment terminal is a mobile phone, and the method comprises the following steps:

step 601: the mobile phone reads and runs system software of the mobile phone stored in a Read-Only form in its Flash ROM and remote payment application software of the mobile phone stored in a Read-Only form in its SIM card, after it is started up;

step 602: the payment card is swiped on the POS terminal, the POS terminal reads the card ID1 of the payment card and sends the ID1 and payment amount to the payment receiving server, and the payment receiving server sends the ID1 and payment amount to the payment server;

step 603: the payment server establishes voice/data communication with the mobile phone, and the mobile phone is bound with the payment card with card ID1; the payment server prompts the payment amount via the mobile phone by voice/data, and prompts for confirming the remote payment by pressing a key “1” on the keypad of the mobile phone or inputting a payment password to the mobile phone/pressing a “Confirm Payment” button displayed by the remote payment software of the mobile phone, or swiping the payment card on the mobile phone or inputting a biometric signature to the mobile phone;

step 604: the user confirms the prompted payment amount is correct and then presses the key “1” or inputs a payment password/presses the “Confirm Payment” button displayed by the remote payment software of the mobile phone, or swipes the payment card on the mobile phone or inputs a biometric signature, and the mobile phone sends remote payment confirmation information to the payment server, wherein, the remote payment confirmation information comprises a DTMF signal corresponding to the key “1” or payment password/a remote payment confirmation message corresponding to the “Confirm Payment” button on the mobile phone, the remote payment confirmation information of the payment card, or a biometric signature;

step 605: the payment server transfers money equal to the payment amount from a remote payment account corresponding to the mobile phone in the payment server to a remote payment receiving account corresponding to the POS terminal in the payment receiving server, after it confirms the received remote payment confirmation information is correct, wherein, the remote payment account, the mobile phone, the payment card, and the remote payment confirmation information are bound to each other, and the remote payment receiving account and the POS terminal are bound to each other.

In the embodiment 6, since the mobile phone uses read-only software after it is started up, harms of computer viruses can be prevented; since the payment server receives remote payment confirmation information via the mobile phone, the confidentiality and privacy of the remote payment is enhanced; since the remote payment account, the mobile phone, the payment card, and the remote payment confirmation information are bound to each other, and the remote payment receiving account and the POS terminal are bound to each other, the controllability of the remote payment is enhanced.

In embodiment 7 of the present invention, a simplified scheme for the embodiment 3 of the present invention is provided, wherein, the payment terminal is a mobile phone, and the method comprises the following steps:

step 701: the mobile phone reads and runs system software of the mobile phone stored in a Read-Only form in its Flash ROM and remote payment application software of the mobile phone stored in a Read-Only form in its SIM card, and establishes encrypted mobile communication with the payment server, after it is started up;

step 702: the POS terminal requests for a serial number 1 from the payment receiving server, and generates a QR code C1 from the serial number 1 and the payment amount and displays the QR code C1, the mobile phone scans the QR code C1 and sends the QR code C1 to the payment server, and the payment server reads the serial number 1 and payment amount in the QR code C1, wherein, the serial number 1 comprises identity information of the payment receiving server;

or, the mobile phone requests for a serial number 2 from the payment server, and generates a QR code C2 from the serial number 2 and displays the QR code C2, the POS terminal scans the QR code C2 and reads the serial number 2 from the QR code C2, and sends the serial number 2 and the payment amount to the payment receiving server, and the payment receiving server sends the serial number 2 and the payment amount to the payment server, wherein, the serial number 2 comprises identity information of the payment server;

or, the mobile phone generates a QR code C3 from the card ID1 of the payment card or a remote payment digital certificate DC1 in the mobile phone and displays the QR code C3, the POS terminal scans the QR code C3 and reads the ID1 or DC1 from the QR code C3, and sends the ID1 or DC1 and the payment amount to the payment receiving server, and the payment receiving server sends the ID1 or DC1 and the payment amount to the payment server, wherein, the ID1 or DC1 comprises the identity information of the payment server, and the ID1 or DC1 is bound to the mobile phone, so that the payment server can identify the corresponding mobile phone according to the ID1 or DC1 sent from the payment receiving server;

step 703: the payment server prompts the payment amount via the mobile phone, and prompts for inputting a payment password to confirm the remote payment;

step 704: the user confirms that the prompted payment amount is correct and then inputs a payment password to the mobile phone, and the mobile phone sends the payment password to the payment server;

step 705: the payment server transfers money equal to the payment amount from a remote payment account corresponding to the mobile phone in the payment server to a remote payment receiving account corresponding to the POS terminal in the payment receiving server, after it confirms the received payment password is correct, wherein, the remote payment account, the mobile phone, and the payment password are bound to each other, and the remote payment receiving account and the POS terminal are bound to each other;

step 706: the POS terminal generates a QR code C4 from the invoice, shopping list and consumption points and displays the QR code C4, and the mobile phone scans the QR code C4 and reads and saves the invoice, shopping list, and consumption points in the QR code C4.

In the embodiment 7, since the serial number and the ID or digital certificate of payment card are transmitted by means of a QR code and the payment card can employs an IC card or magnetic strip card, the compatibility of the remote payment is enhanced; since the mobile phone sends the payment password to the payment server by encrypted mobile communication, the confidentiality and privacy of the remote payment is further improved.

In embodiment 8 of the present invention, a simplified scheme for the embodiment 5 of the present invention is provided, wherein, the payment terminal is a mobile phone, and electronic cash is stored in a SIM card of the mobile phone. The method comprises the following steps:

step 801: the mobile phone reads and runs system software of the mobile phone stored in a Read-Only form in its Flash ROM and NFC payment application software of the mobile phone stored in a Read-Only form in its SIM card, after it is started up;

step 802: the POS terminal generates a QR code C1 from the identity certification information of the POS terminal and the payment amount and displays the QR code C1, and the mobile phone scans the QR code C1, reads and authenticate the identity certification information of the POS terminal in the QR code C1, reads the payment amount in the QR code C1, and prompts for confirming the payment amount;

step 803: the user confirms the payment amount on the mobile phone, the mobile phone instructs the SIM card to deduct electronic cash equal to the payment amount, generates a QR code C2 from the identity certification information of the mobile phone and the deduction information and displays the QR code C2, the POS terminal scans the QR code C2, reads and authenticates the identity certification information of the mobile phone and the deduction information in the QR code C2, and adds electronic cash equal to the payment amount;

step 804: the POS terminal generates a QR code C3 from the invoice, shopping list and consumption points and displays the QR code C3, and the mobile phone scans the QR code C3 and reads and saves the invoice, shopping list, and consumption points in the QR code C4.

In the embodiment 8, since the NFC payment protocol is transmitted by means of a QR code, the compatibility of the NFC payment is improved.

While the present invention is described above in some preferred embodiments, the present invention is not limited to those preferred embodiments. Any modification, equivalent replacement, and improvement made without departing from the spirit and principle of the present invention shall be deemed as falling into the protected domain of the present invention.

1. An electronic payment system, comprising:
a remote payment subsystem; and
a NFC payment subsystem that are independent respectively,
wherein remote payment subsystem comprises:
a payment card,
a payment terminal connected with the payment card through near field communication (NFC),
a payment server connected with the payment terminal through a mobile communication network,
a payment receiving server connected with the payment server through a data communication network,
a payment receiving terminal connected with the payment receiving server through the mobile communication network, and
a payment receiving card connected with the payment receiving terminal through NFC,
wherein the payment terminal is connected with the payment receiving terminal through NFC; and
wherein the NFC payment subsystem comprises:
a payment card,
a payment terminal connected with the payment card through NFC,
a payment receiving terminal connected with the payment terminal through NFC, and
a payment receiving card connected with the payment receiving terminal through NFC.

2. The electronic payment system according to claim 1,
wherein, in the remote payment subsystem the payment card is connected with the payment terminal through NFC, and is used to execute two-way authentication with the payment terminal, and execute two-way authentication with the payment server via the payment terminal;
wherein the payment terminal is connected with the payment receiving terminal and the payment card through NFC respectively, and connected with the payment server through the mobile communication network, and is used to read and run system software of the payment terminal and remote payment application software of the payment terminal that are stored in a Read-Only form, after it is started up; is used to execute two-way authentication with the payment card and the payment server, and execute two-way authentication with the payment receiving terminal on the basis of an assigned key; and is used to send payment amount and payment password inputted into the payment terminal to the payment server;
wherein the payment server is connected with the payment receiving server through the data communication network and connected with the payment terminal through the mobile communication network, and is used to execute two-way authentication with the payment terminal, and execute two-way authentication with the payment card via the payment terminal; is used to execute two-way authentication and key negotiation with the payment receiving server, and assign a key obtained through negotiation to the payment terminal; is used to prompt via the payment terminal for inputting payment amount and payment password into the payment terminal, and receive the payment amount and payment password via the payment terminal; and is used to transfer money equal to the payment amount from a remote payment account corresponding to the payment terminal in the payment server into a remote payment receiving account corresponding to the payment receiving terminal in the payment receiving server;
wherein the payment receiving card is connected with the payment receiving terminal through NFC, and is used to execute two-way authentication with the payment receiving terminal, and execute two-way authentication with the payment receiving server via the payment receiving terminal;
wherein the payment receiving terminal is connected with the payment receiving server through the mobile communication network, connected with the payment terminal and the payment receiving card through NFC respectively, and is used to read and run system software of the payment receiving terminal and remote payment application software of the payment receiving terminal that are stored in a Read-Only form, after it is started up; and is used to execute two-way authentication with the payment receiving card and the payment receiving server, and execute two-way authentication with the payment terminal on the basis of an assigned key; and
wherein the payment receiving server is connected with the payment receiving terminal through the mobile communication network, connected with the payment server through the data communication network, and is used to execute two-way authentication with the payment receiving terminal, and execute two-way authentication with the payment receiving card via the payment receiving terminal; and is used to execute two-way authentication and key negotiation with the payment server, and assign a key obtained through negotiation to the payment receiving terminal.

3. The electronic payment system according to claim 1,
wherein, in the NFC payment subsystem the payment card is connected with the payment terminal through NFC, and is used to execute two-way authentication with the payment terminal; is used to calculate A1=A1−P according to payment balance A1 and payment amount P applied for by the payment terminal, save payment details R1 and new payment balance A1, and approve the payment terminal to pay by NFC payment; is used to calculate A1=A1+P, and save payment details R1 and new payment balance A1 if it receives a notification on NFC payment failure from the payment terminal; and is used to take the stored payment details R1 and payment balance A1 as backup data for payment details R1′ and payment balance A1′ stored in the payment terminal;
wherein the payment terminal is connected with the payment card and the payment receiving terminal through NFC respectively, and is used to read and run system software of the payment terminal and NFC payment application software of the payment terminal that are stored in a Read-Only form, after it is started up; is used to apply to the payment card for paying by NFC payment and send the payment amount P to the payment card, after it receives the inputted payment amount P; is used to execute two-way authentication with the payment receiving terminal after the payment card approves the payment terminal to pay by NFC payment, and send the payment amount P to the payment receiving terminal if the two-way authentication is successful; otherwise notify the payment card of the NFC payment failure; is used to transfer electronic money in amount P from a NFC payment account of the payment terminal to a NFC payment receiving account of the payment receiving terminal; is used to calculate A1=A1′−P according to payment balance A1′ and payment amount P, and save payment details R1′ and new payment balance A1′; and is used to take the stored payment details R1 and payment balance A1 as backup data for the payment details R1′ and payment balance A1′ stored in the payment terminal;
wherein the payment receiving card is connected with the payment receiving terminal through NFC, and is used to execute two-way authentication with the payment receiving terminal after it receives an application for receiving NFC payment and the payment amount P sent from the payment receiving terminal; is used to calculate A2=A2+P according to payment receiving balance A2 and payment amount P, save payment receiving details R2 and new payment receiving balance A2, and approve the payment receiving terminal to pay by NFC payment; and is used to take the stored payment receiving details R2 and payment receiving balance A2 as backup data for payment receiving details R2′ and payment receiving balance A2′ stored in the payment receiving terminal; and
wherein the payment receiving terminal is connected with the payment receiving card and the payment terminal through NFC, and is used to read and run system software of the payment receiving terminal and NFC payment application software of the payment receiving terminal that are stored in a Read-Only form, after it is started up; is used to prompt for confirming the payment amount P after it receives the payment amount P sent from the payment terminal, and apply to the payment receiving card for paying by NFC payment and send the payment amount P to the payment receiving card after it receives a confirmation; is used to calculate A2′=A2′+P according to payment receiving balance A2′ and payment amount P, and save payment receiving details R2′ and new payment receiving balance A2′; and is used to take the stored payment receiving details R2′ and payment receiving balance A2′ as backup data for the payment receiving details R2 and payment receiving balance A2 stored in the payment receiving card.

4. The electronic payment system according to claim 1, wherein, the payment terminal is a mobile terminal, and the payment receiving terminal is a mobile terminal or POS terminal, the mobile terminal comprises mobile phone, PDA, Tablet PC, or laptop computer, and, if the payment receiving terminal is a POS terminal, the electronic payment system doesn't comprise the payment receiving card.

5. A remote payment method based on the electronic payment system according to the claim 2, the payment method comprising the following steps:
step 201: reading and running system software of the payment terminal and remote payment application software of the payment terminal that are stored in a Read-Only form, by the payment terminal, after the payment terminal is started up;
step 202: executing two-way authentication, by the payment terminal, with the payment card and the payment server respectively; and executing two-way authentication, by the payment server, with the payment card via the payment terminal;
step 203: reading and running system software of the payment receiving terminal and remote payment application software of the payment receiving terminal that are stored in a Read-Only form, by the payment receiving terminal, after the payment receiving terminal is started up;
step 204: executing two-way authentication, by the payment receiving terminal, with the payment receiving card and the payment receiving server respectively; and executing two-way authentication, by the payment receiving server, with the payment receiving card via the payment receiving terminal;
step 205: swiping the payment terminal and/or the payment card on the payment receiving terminal; reading the Payment ID of the payment terminal and/or the payment card, by the payment receiving terminal; sending the Payment ID, by the payment receiving terminal, to the payment receiving server; and sending the Payment ID, by the payment receiving server, to the payment server;
step 206: executing two-way authentication and key negotiation, by the payment server, with the payment receiving server; assigning a key obtained through negotiation, by the payment server, to the payment terminal; assigning a key obtained through negotiation, by the payment receiving server, to the payment receiving terminal; and executing two-way authentication, by the payment terminal, with the payment receiving terminal on the basis of the assigned keys;
step 207: prompting via the payment terminal for inputting payment amount and payment password into the payment terminal, and receiving the payment amount and payment password via the payment terminal, by the payment server; and
step 208: transferring money equal to the payment amount from a remote payment account corresponding to the payment terminal in the payment server to a remote payment receiving account corresponding to the payment receiving terminal in the payment receiving server, by the payment server, after the payment server confirms the received payment password is correct.

6. The remote payment method according to claim 5, wherein, in the step 201, the payment terminal reads and runs system software of the payment terminal and remote payment application software of the payment terminal that are stored in a Read-Only form, after it is started up; and in the step 203, the payment receiving terminal reads and runs system software of the payment receiving terminal and remote payment application software of the payment receiving terminal that are stored in a Read-Only form, after it is started up.

7. The remote payment method according to claim 5, wherein, in the step 202, the payment card executes two-way authentication with the payment terminal, and executes two-way authentication with the payment server via the payment terminal; in the step 204, the payment receiving card executes two-way authentication with the payment receiving terminal, and executes two-way authentication with the payment receiving server via the payment receiving terminal; and in the step 206, the payment terminal executes two-way authentication with the payment receiving terminal on the basis of the keys assigned by the payment server and the payment receiving server.

8. The remote payment method according to claim 5, wherein, in the step 207, the payment server receives remote payment confirmation information via the payment terminal, and the remote payment confirmation information comprises the payment password, a DTMF signal corresponding to keystroke confirmation operation, remote payment confirmation information of the payment terminal, remote payment confirmation information of the payment card and/or a biometric signature.

9. The remote payment method according to claim 5, wherein, in the steps, the remote payment account, the payment terminal, the payment card, and the remote payment confirmation information are bound to each other, and the remote payment receiving account, the payment receiving terminal, and the payment receiving card are bound to each other.

10. The remote payment method according to claim 5, wherein, in each of the steps, electronic payment information is generated and can be transmitted by means of a QR code, the electronic payment information comprises: ID of the payment card, ID of the payment receiving card, ID of the payment terminal and/or ID of the payment receiving terminal, and serial number, digital certificate, payment amount, invoice, shopping list and/or consumption points, the serial number comprises the identity information of the payment server or the identity information of the payment receiving server, and is used to initiate remote payment.

11. An NFC payment method based on the electronic payment system according to the claim 3, the payment method comprising the following steps:
step 401: reading and running system software of the payment receiving terminal and NFC payment application software of the payment receiving terminal that are stored in a Read-Only form, by the payment receiving terminal, after the payment receiving terminal is started up;
step 402: reading and running system software of the payment terminal and NFC payment application software of the payment terminal that are stored in a Read-Only form, by the payment terminal, after the payment terminal is started up;
step 403: inputting payment amount P into the payment terminal;
step 404: applying to the payment card for paying by NFC payment, and sending the payment amount P to the payment card, by the payment terminal;
step 405: executing two-way authentication, by the payment card, with the payment terminal;
step 406: calculating A1=A1−P according to payment balance A1 and payment amount P, and saving payment details R1 and new payment balance A1, by the payment card;
step 407: approving the payment terminal to pay by NFC payment, by the payment card;
step 408: executing two-way authentication, by the payment terminal, with the payment receiving terminal;
step 409: judging whether the two-way authentication with the payment receiving terminal is successful, by the payment terminal; if the two-way authentication is successful, jumping to step 412; otherwise jumping to step 410;
step 410: notifying the payment card of the NFC payment failure, by the payment terminal;
step 411: calculating A1=A1+P according to payment balance A1 and payment amount P, and saving payment details R1 and new payment balance A1, by the payment card; thus, terminating the entire process;
step 412: sending the payment amount P, by the payment terminal, to the payment receiving terminal;
step 413: prompting for confirming the payment amount P, by the payment receiving terminal; and applying to the payment receiving card for paying by NFC payment and sending the payment amount P to the payment receiving card, by the payment receiving terminal, after the payment receiving terminal receives a confirmation;
step 414: executing two-way authentication, by the payment receiving card, with the payment receiving terminal;
step 415: calculating A2=A2+P according to payment receiving balance A2 and payment amount P, and saving payment receiving details R2 and new payment receiving balance A2, by the payment receiving card;
step 416: approving the payment receiving terminal to pay by NFC payment, by the payment receiving card;
step 417: transferring electronic money in amount P, by the payment terminal, from an NFC payment account of the payment terminal to an NFC payment receiving account of the payment receiving terminal; and
step 418: calculating A1=A1′−P according to payment balance A1′ and payment amount P, and saving payment details R1′ and new payment balance A1′, by the payment terminal; and calculating A2′=A2′+P according to payment receiving balance A2′ and payment amount P, and saving payment receiving details R2′ and new payment receiving balance A2′, by the payment receiving terminal.

12. The NFC payment method according to claim 11, wherein, in the step 401, the payment receiving terminal reads and runs system software of the payment receiving terminal and NFC payment application software of the payment receiving terminal that are stored in a Read-Only form, and it is started up; and in the step 402, the payment terminal reads and runs system software of the payment terminal and NFC payment application software of the payment terminal that are stored in a Read-Only form, after it is started up.

13. The NFC payment method according to claim 11, wherein, in the step 405, the payment card executes two-way authentication with the payment terminal; and in the step 414, the payment receiving card executes two-way authentication with the payment receiving terminal.

14. The NFC payment method according to claim 11, wherein, in the steps, the NFC payment account, the payment terminal, and the payment card are bound to each other, and the NFC payment receiving account, the payment receiving terminal, and the payment receiving card are bound to each other.

15. The NFC payment method according to claim 11, wherein, in each of the steps, electronic payment information is generated and can be transmitted by means of a QR code, and the electronic payment information comprises NFC payment protocol, digital certificate, payment amount, invoice, shopping list and/or consumption points.

16. The NFC payment method according to claim 11, wherein, the payment details R1 and payment balance A1 stored in the payment card and the payment details R1′ and payment balance A1′ stored in the payment terminal serve as backup data for each other; and the payment receiving details R2 and payment receiving balance A2 stored in the payment receiving card and the payment receiving details R2′ and payment receiving balance A2′ stored in the payment receiving terminal serve as backup data for each other.
